(19) United States
(12) Patent Application Publication
(10) Pub. No.: US 2007/0121428 A1
(43) Pub. Date: May 31, 2007

(54) Information recording apparatus

(76) Inventors: Yuji Fujita, Yokohama (JP); Yasuo Amano, Yokohama (JP); Akemi Hirotsune, Saitama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/604,805

(22) Filed: Nov. 28, 2006

(30) Foreign Application Priority Data
Nov. 28, 2005 (JP) 2005-342490

(51) Int. Cl. G11B 11/00

(52) U.S. Cl. 369/13.01

(57) ABSTRACT

A multilayer optical recording apparatus excellent in high-speed recording and long-term reliability is realized, the apparatus preventing the lowering of a speed of switching recording layers by preventing an increase in contact resistance attributable to wear of a rolling part or of a sliding part of the apparatus. In a multilayer optical recording apparatus using an electrochromic material, a rotary transformer is provided as electromagnetic induction means for supplying power from a power source to a medium.

### CLAIM OF PRIORITY

The present application claims priority from Japanese application JP 2005-342490 filed on Nov. 28, 2005, the content of which is hereby incorporated by reference into this application.

### CROSS REFERENCE TO RELATED APPLICATION

U.S. patent application Ser. No. 11/366,591 is a co-pending application of this application. The content of which is incorporated herein by cross-reference.

### BACKGROUND OF THE INVENTION

1. Field of the Invention

The present invention relates to an information recording apparatus for recording information on a medium by use of light.

2. Description of the Prior Art

In order to improve recording density, much effort has heretofore been made to reduce an area of a light spot by making a wavelength of a light source shorter. However, the shortening of wavelength of the light source has been approaching its limit. For this reason, a multilayer optical recording method using linearity and transmission of light is expected as a future technology.

As disclosed in JP No. 2004-310912A, for example, a layer-selection-type multi information layer optical disk using an electrochromic material makes it possible to realize higher recording density of an optical recording apparatus. The layer-selection-type multi information layer optical disk is an optical disk formed by depositing, on a polycarbonate substrate, a plurality of structures each with a recording layer interposed between transparent electrode layers holding the recording layer. When a predetermined voltage is applied to a layer on which or from which recording or readout is wished to be performed, a state of the recording layer is changed from transparent to colored. Accordingly, absorption and reflection of recording light or of reading light are increased so that recording or readout is made possible. A spot irradiated with light is altered and set in the transparent state to be recorded as information. Since all of the layers, except one to which the voltage is applied, are transparent, recording or reading can be performed only on the specific layer to which the voltage is applied.

In the above conventional example, a rolling part or a sliding part, such as a bearing and a slip ring, which is installed around a rotation axis of the optical disk, is used to supply a voltage to the optical disk from a stationary part of the recording apparatus. By use of the method described above, the voltage can be supplied to a predetermined recording layer in the optical disk to be rotated.

However, in the above method, the rolling part or the sliding part is worn away while being used for a long period of time. As time passes, an area of an oxide film is increased on a surface of a worn portion. Accordingly, electrical resistance in the worn portion is increased, and a voltage drop in the rolling part or in the sliding part is increased. As a result, the voltage applied to each of the recording layers is lowered. When the applied voltage is lowered, a speed, at which the state of the recording layer is changed from transparent to colored, is slowed down. Thus, it takes a longer time to switch the recording layers, and recording and reading speeds of the apparatus are slowed down. When the area of the oxide film described above is increased, the electrical resistance is further increased to ultimately be an infinite resistance. Consequently, no current can be supplied to the recording layer, and multilayer recording cannot be performed.

Moreover, in the method described above, one bearing or slip ring is required to apply a voltage to one transparent electrode layer. Specifically, in order to respond to an increase in the number of recording layers, a number of bearings or slip rings have to be stacked on one another. A thickness of these parts increases a height of the whole recording apparatus. For this reason, it is difficult to concurrently increase a recording capacity, and to miniaturize the apparatus.

### SUMMARY OF THE INVENTION

It is an object of the present invention to realize a multilayer optical recording apparatus excellent in high-speed recording and long-term reliability, the apparatus preventing the lowering of a rate of switching recording layers due to an insufficient supply voltage. This is achieved by preventing an increase in contact resistance attributable to wear of a rolling part or of a sliding part, and a resultant voltage drop caused by the increase. Moreover, it is another object of the present invention to realize a multilayer optical recording apparatus which can achieve both an increase in a recording capacity and miniaturization of the apparatus without increasing a height of the whole apparatus even when the number of recording layers is increased.

The above objects are achieved by providing electromagnetic induction means for supplying power from a power source to a medium in a multilayer optical recording apparatus using an electrochromic material. The above electromagnetic induction means may include pairs of coils each provided to a corresponding one of a rotating body holding the medium and an irrotational body rotatably supporting the rotating body; and magnetic substances each of which surrounds the coils. Thus, the power can be contactlessly supplied to the medium to be rotated. Thereby, the conventional problem attributable to the wear of the rolling part or of the sliding part can be solved.

Moreover, it is desirable that a current control circuit for supplying a current to a specific one of the recording layers be installed in the rotating body, and that electromagnetic induction means for supplying control signals to the current control circuit be provided. The above electromagnetic induction means may include pairs of coils each provided to a corresponding one of a rotating body holding the medium and an irrotational body rotatably supporting the rotating body; and magnetic substances each of which surrounds the coils. Thus, the signals can be contactlessly supplied to the current control circuit to be rotated, and the conventional problem attributable to the wear of the rolling part or of the sliding part can be solved. Moreover, by providing both of the electromagnetic induction means for supplying the power and the electromagnetic induction means for supplying the control signals, functions of the current control circuit enable the switching of polarities of the current and the switching of the recording layers. With such a configuration, regardless of an increase in the number of recording layers, the current can be supplied to a specific one of the recording layers by the above two electromagnetic induction means.

With regard to conventional practices, in order to respond to the increase in the number of recording layers, a number of bearings or slip rings have to be stacked on one another. However, with the configuration described above, a height of the whole apparatus is constant no matter how much the number of recording layers is increased. Hence, it is made possible to realize a multilayer optical recording apparatus which can achieve both an increase in a recording capacity and miniaturization of the apparatus.

In order to supply the control signals to the current control circuit, light emitting means and light receiving means for supplying the signals may be provided between a current source and the medium. Thereby, the signals can be contactlessly supplied to the current control circuit to be rotated, and the conventional problem attributable to the wear of the rolling part or of the sliding part can be solved as in the case with the electromagnetic induction means. Moreover, by providing both of the electromagnetic induction means for supplying the power and the light emitting and receiving means for supplying the control signals, functions of the current control circuit enable the switching of the polarities of the current and the switching of the layers. With such a configuration, regardless of an increase in the number of recording layers, the current can be supplied to a specific one of the recording layers. Thus, it is made possible to realize a multilayer optical recording apparatus which can achieve both an increase in a recording capacity and miniaturization of the apparatus.

It is preferable that the current control circuit be mounted on a fixing board for fixing the medium, and that the electromagnetic induction means, which is mounted on a hub, and the current control circuit be connected to each other by use of a flexible substrate. With the configuration described above, the following effects are brought about in a case where the number of recording layers is increased. Although the number of terminals for connecting the medium to the current control circuit is increased, connection between the current control circuit and the electromagnetic induction means can be realized, as described above, by at least two lines including a wiring for supplying power and a wiring for supplying control signals. Thus, multi-terminal connections between the medium and the current control circuit can be realized by use of contact pins and a multilayer printed circuit board, and the excellent connection between the current control circuit and the electromagnetic induction means, which requires only the two lines of wirings, can be realized by use of the flexible substrate.

With the configuration as described above, the number of connection pins on the flexible substrate is set constant regardless of the number of recording layers. Since the number of pins is not increased, a connection structure excellent in long-term connection reliability can be realized at low costs. Moreover, even if force is applied to the fixing board when the medium is mounted on the fixing board, the force applied to the electromagnetic induction means is reduced because of a flexible and deformable structure of the flexible substrate. In order to enhance connection efficiency, the electromagnetic induction means provided to both of the rotating body and the irrotational body are positioned in a way that the two electromagnetic induction means face each other with a space of several 10 μm therebetween. When the force applied to the electromagnetic induction means is reduced, the coils or magnetic substances are no longer caused to be in contact with each other or mesh with each other. Thus, the medium can be rotated stably for a long period of time.

Furthermore, by providing a space between the fixing board and the hub, by forming the fixing board or the current control circuit into a flexible structure or by forming a connection part between the fixing board and a rotation axis into a flexible structure, the force applied to the electromagnetic induction means mounted on the hub is further reduced. Thereby, the incidence of contact and meshing between the coils or between the magnetic substances is reduced. Accordingly, the medium can be rotated stably for a longer period of time.

The electromagnetic induction means may be provided on a plane parallel to the rotation axis, the rotating body and the irrotational body facing each other on the plane. Thereby, even if force is applied to the rotating body when the medium is mounted on the fixing board, the rotating body and the irrotational body are shifted approximately parallel to the plane. Accordingly, a change in a space between the rotating body and the irrotational body is reduced. Thus, the incidence of contact and meshing between the coils or between the magnetic substances is reduced. As a result, the medium can be rotated stably for a long period of time.

According to the present invention, it is made possible to realize a recording apparatus excellent in high-speed recording and long-term reliability, the apparatus preventing the lowering of a rate of switching recording layers due to wear of a rolling part or of a sliding part. Moreover, it is made possible to realize an information recording apparatus which can achieve both an increase in a recording capacity and miniaturization of the apparatus without increasing a height of the whole apparatus even when the number of recording layers is increased.

### BRIEF DESCRIPTION OF THE DRAWINGS

FIG. 1 is a cross-sectional view of an information recording apparatus according to a first embodiment of the present invention.

FIG. 2 is a cross-sectional view of the information recording apparatus in a case where force is applied to a fixing board according to the first embodiment of the present invention.

FIG. 3 is a cross-sectional view of an information recording apparatus according to a second embodiment of the present invention.

FIG. 4 is a cross-sectional view of an information recording apparatus according to a third embodiment of the present invention.

FIG. 5 is a cross-sectional view of an information recording apparatus according to a fourth embodiment of the present invention.

FIG. 6 is a cross-sectional view of an information recording apparatus according to a fifth embodiment of the present invention.

FIG. 7 is a view showing operations of recording and reading information according to the embodiments.

FIG. 8 is a block diagram showing an electric circuit required for the switching of recording layers according to the present invention.

FIG. 9 is a graph showing changes in V₁₂ and V₂₃ over time in a first switching method.

FIG. 10 is a graph showing changes in V₁₂ and V₂₃ over time in a second switching method.

FIG. 11 is a cross-sectional view of an information recording medium according to the present invention.

FIG. 12 is an enlarged view of an electrode part in the information recording medium according to the present invention.

### DETAILED DESCRIPTION OF THE PREFERRED EMBODIMENTS

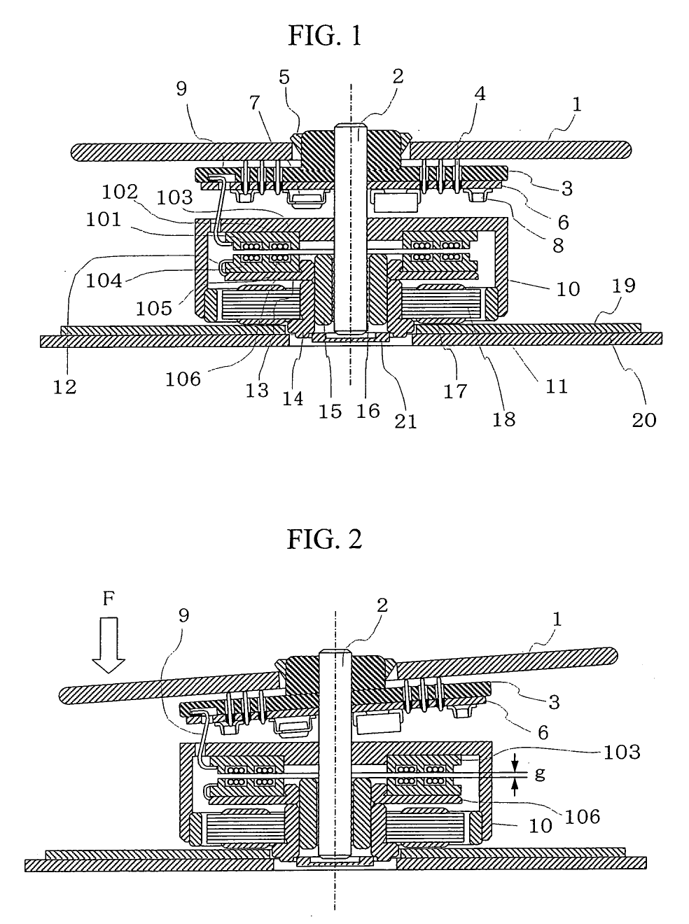

With reference to the drawings, an information recording apparatus according to the present invention will be described below. FIG. 1 is a cross-sectional view taken along a disk rotation axis of an information recording apparatus according to a first embodiment of the present invention.

A disk 1 is a layer-selection-type multi information layer optical disk formed by depositing a plurality of structures, each of which includes a recording layer made of an electrochromic material, two transparent electrode layers holding the recording layer interposed therebetween. Since an internal structure of the disk and a manufacturing process thereof are disclosed in JP No. 2003-3462378A or JP No. 2004-310912A, detailed descriptions thereof will be omitted.

In an inner circumferential region of the disk 1, a plurality of draw-out electrodes are formed for supplying currents to the transparent electrodes holding one of the recording layers therebetween. Ends of the respective draw-out electrodes are exposed on a surface of an inner circumferential part of the disk I facing a fixing board 3. On a surface of the fixing board 3, a plurality of contact pins 4 are respectively provided in positions corresponding to those of the draw-out electrodes. Each of the contact pins 4 has spring characteristics, which allows the contact pins 4 to stretch and contract in a vertical direction.

When the disk 1 is mounted on the fixing board 3, an innermost circumferential part of the disk 1 is fitted into a disk retainer 5. The disk retainer 5 includes a spring, and exerts force pressing the entire disk 1 toward the fixing board 3. Thereby, the disk 1 and the fixing board 3 are positioned close to each other, and the draw-out electrodes in the disk I are in contact with the respective contact pins 4. Even when the disk 1 is warped or tilted, the draw-out electrodes and the contact pins 4 can be in contact with each other since the contact pins 4 stretch and contract in the vertical direction.

The fixing board 3 and a hub 10 are fixed to a rotation axis 2, and can be rotated together with the rotation axis 2. On a bottom surface of the fixing board 3, a current control circuit board 6 is mounted for controlling currents to be supplied to the respective recording layers in the disk 1. By using solder and the like, each of the contact pins 4 is electrically connected to a corresponding one of electrodes formed inside the respective through-holes in the current control circuit board 6.

Passive components 8, such as a capacitor and a resistor, and an IC 7, which are required for current control, are mounted on the circuit board 6. When the disk 1 is rotated, the circuit board is also rotated. Accordingly, dynamic balance at the time of rotation is minimized by installing the components in a way that a total moment of the components when viewed from the center of the rotation axis is minimized. Consequently, it is made possible to realize a rotation system with few oscillations and with small power consumption of a motor.

On a lower surface of the hub 10, provided is a rotary transformer 100 which is electromagnetic induction means for supplying power and control signals to the current control circuit board 6. The rotary transformer 100 is formed of the following parts, including a rotor-side power supply coil 101, a rotor-side signal supply coil 102 and a rotor-side core 103, all of which are attached to the side of the hub 10 to be rotated; and a stator-side power supply coil 104, a stator-side signal supply coil 105 and a stator-side core 106, all of which are attached to the side of a stationary sleeve 13.

The coils 101 and 104 have a concentric winding structure around the rotation axis 2, and face each other with a minute space of about 30 μm therebetween. When an alternating current of about 100 kHz is supplied from a power source circuit, which is provided in a circuit board 19 on a base 20, to the coil 104 through a wiring 12, an alternating current magnetic flux is generated around the coil 104. The cores 103 and 106 are made of a soft magnetic material which allows the alternating current magnetic flux to pass through easily, the soft magnetic material including ferrite powder containing zinc, manganese and the like. The alternating current magnetic flux passes through the stator-side core 106, and a part of the flux enters into the rotor-side core 103 facing the core 106. A flux change inside the rotor-side core 103 generates an induced electromotive force in the coil 101.

Electrodes on both ends of the coil 101 are respectively connected to electrodes of a flexible substrate 9, and the flexible substrate 9 is connected to the current control circuit board 6. The alternating-current induced electromotive force in the coil 101 is converted into a direct current by a smoothing circuit in the current control circuit board 6, and is then supplied to each of the recording layers in the disk 1 through a corresponding one of the contact pins 4.

Since the coils 101 and 104 and the cores 103 and 106 all have a concentric structure around the rotation axis 2, there is no change in a magnetic circuit in principle even when a rotation speed of the hub 10 is changed. Thereby, amplitude and frequency of the alternating current magnetic flux passing through the core are set constant regardless of the rotation speed of the hub. Thus, the power can be supplied stably to the disk 1 to be rotated.

As in the case with the coils 101 and 104, the coils 102 and 105 face each other with a minute space of about 30 μm therebetween. When an alternating current is supplied to the coil 105 from a control circuit provided to the circuit board 19 on the base 20, the alternating current magnetic flux is generated in the cores 106 and 103, and the induced electromotive force is generated in the coil 102 as in the case described above.

Electrodes respectively on both ends of the coil 102 are connected to the current control circuit board 6 through the flexible substrate 9. The induced electromotive force described above is amplified and converted inside the current control circuit board 6, and is utilized for switching the recording layers and for controlling polarities of the current and current values.

In the first embodiment, the coil for supplying the power and the coil for supplying the control signals utilize the common core. For this reason, in order to prevent the two coils from interfering with each other, frequency components of the alternating currents of the respective two coils need to be controlled with care so that the two alternating currents are not affected by each other. For example, in a case where a basic frequency of the alternating current supplied to the coil 104 is set at 100 kHz, it is desirable that a frequency at 100 kHz and those higher than 100 kHz be avoided for a basic frequency of the alternating current supplied to the coil 105. Alternatively, by setting the basic frequency to 1 MHz or more, probability of interference of higher frequency components is lowered.

A ring-shaped rotor magnet 11 is fixed to a lowermost part of the hub 10. Moreover, a motor stator ring 14 and a bearing 15 are provided in a way that the motor stator ring 14 and the bearing 15 are in contact with an inner circumference of the sleeve 13. A dynamic pressure generating fluid 16 fills a space between the bearing 15 and the rotation axis 2. A cap 21 for preventing the dynamic pressure generating fluid 16 from leaking is attached to the bottom of the rotation axis 2. Although the fluid bearing is adopted in this embodiment, another structure, for example, a bearing structure using a ball-bearing may also be adopted.

A motor stator core 18 and a motor winding 17 are disposed on an outer circumference of the motor stator ring 14. When a predetermined drive current is supplied to the motor winding 17, a torque is generated between the motor stator core 18 and the rotor magnet 11. Accordingly, the rotation structure described above including the hub 10 can be rotated at a speed of thousands of revolutions per minute.

The circuit board 19 and the base 20 are installed below the motor stator ring 14. On the circuit board 19, a power source and a control signal source for supplying the power to the disk 1 and other electronic circuits necessary for the recording apparatus are mounted. The circuit board 19 and the coils 104 and 105 are connected to each other with the wiring 12. Thus, the necessary power and control signal can be supplied to the coils.

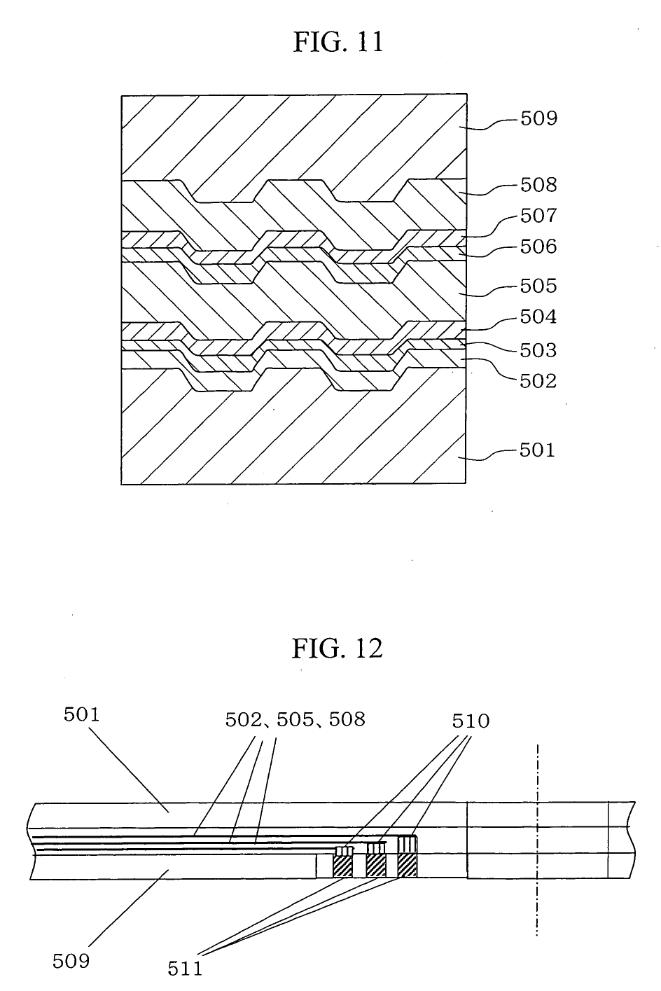

Next, a recording and reading example using the first embodiment will be described. FIG. 11 shows a cross-sectional view of a structure of a disk. Here, FIG. 11 shows a two-layer disk for simplicity. However, a disk manufacturing method and a recording and reading method for disks having three layers or more are the same as those for the two layer disk. As electrochromic layers in the disk 1, WO₃ layers 503 and 506 made of an inorganic material are used. As solid electrolyte layers, Ta₂O₅ layers 504 and 507 are used. The disk has superposed structures in each of which two of ITO transparent electrode layers 502, 505 and 508 hold a pair of WO₃ layer and Ta₂O₅ layer interposed therebetween. The structure, in which two of the ITO transparent electrode layers hold a pair of WO₃ layer and Ta₂O₅ layer interposed therebetween, is repeated twice to form two layers which can be colored, and the three transparent electrode layers on a polycarbonate substrate 501 with a thickness of 0.6 mm and a diameter of 120 mm, the polycarbonate substrate 501 having lands and grooves for tracking. In order to protect these recording layers and electrode layers, a polycarbonate substrate 509 having approximately the same thickness as that of polycarbonate substrate 509 is attached by use of a ultraviolet light curing resin.

FIG. 12 is an enlarged view showing an example of an electrode part in the information recording medium according to the present invention. In the inner circumferential part of the disk, three concentric ring-shaped metal electrodes 511 are attached as draw-out electrodes for supplying currents to the three transparent electrode layers described above. The metal electrodes are in contact with the respective transparent electrode layers through conductive resins 510. The disk 1 thus completed is mounted on the fixing board 3, and the concentric metal electrodes 511 and the contact pins 4 are caused to be in contact with each other.

Specifications of currents applied to the recording layers are as follows.
1. A positive voltage for coloring and a negative voltage for decoloring are applied to each of to the two recording layers.
2. Maximum voltage is 5V for both of the positive and negative voltages.
3. Maximum current is 100 mA.
4. Rise time required for the positive and negative voltages to reach 90% of the maximum value is 100 microseconds or less.
5. Coloring and decoloring are repeated 100 times or more.

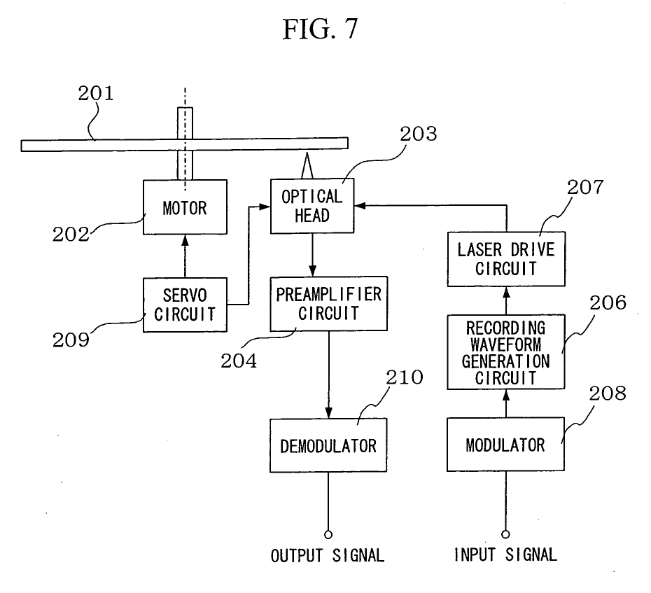

With reference to FIG. 7, operations of recording and reading information according to this embodiment will be described below.

First, an optical disk 201 is rotated and driven by use of a motor 202. As a method of controlling the number of motor rotation, an adopted method is a ZCAV (Zoned Constant Linear Velocity), in which the number of rotation of the disk is changed for each of zones where recording and reading are performed. The optical disk 201 is rotated at a linear velocity of 15 m/s relative to a light spot. Here, recording and reading are performed at the linear velocity of 15 m/s. Meanwhile, there is no problem with power feeding even when the number of rotation of the disk is controlled, for example, by setting the linear velocity faster or slower than 15 m/s, or by setting a constant angular velocity.

Input signals supplied from outside of the recording apparatus are inputted to a modulator 208 by using 8 bits as 1 unit. Here, an 8-16 modulation method is used. This is a modulation method of converting 8-bit information into 16-bit information. By use of the above method, information having mark lengths of 3T to 14T each corresponding to the 8-bit information is recorded on the disk. In this event, T denotes a clock period at the time when information is recorded. Digital signals respectively having 3T to 14T converted by the modulator 208 are transferred to a recording waveform generation circuit 206 to generate multi-pulse recording waveforms. The recording waveform generation circuit 206 causes the signals respectively having 3T to 14T to each correspond to any one of “0” and “1” alternately in a time-series manner.

The recording waveform generated by the recording waveform generation circuit 206 is transferred to a laser drive circuit 207. Thereafter, the laser drive circuit 207 causes a semiconductor laser in an optical head 203 to emit light based on the recording waveform. The optical head 203 includes a semiconductor laser having a light wavelength of 660 nm as a laser for recording information.

After a predetermined one of the layers is colored by applying a current thereto, the laser is focused on the recording layer in the optical disk 201 by use of an objective lens having a lens NA of 0.65 while using a servo circuit 209 to control the laser. Thus, information is recorded by irradiation of the laser beam. Tracking is performed by use of a land and groove method. A recording power is set at 30 mW, and the power is reduced to a reading power at times other than a recording pulse.

The optical head described above is also used to read the recorded information. The reading power is set at 1 mW. A predetermined one of the layers is colored by applying a current thereto, and the recorded mark is irradiated with the laser beam. Thereafter, light reflected from the mark and from portions other than the mark is detected to obtain a reading signal. Subsequently, amplitude of the reading signal is increased by a preamplifier 204, and the signal is converted into 8-bit information for every 16 bits by a demodulator 210 to obtain an output signal. By performing the operation described above, reading of the recorded mark is completed.

In a case where mark edge recording is performed under the conditions described above, a mark length of a 3T mark, which is the shortest mark, is about 0.40 μm, and a mark length of a 14T mark, which is the longest mark, is about 1.96 im. A recording signal includes dummy data, in which a 4T mark and a 4T space are repeated, in beginning and end portions of an information signal.

In this event, the recording is performed by using the laser wavelength of 660 nm and the NA of 0.65. However, a laser having a shorter wavelength of 405 nm or the like may be used. Moreover, the recording can be similarly performed even in a case where a different NA, such as a NA of 0.85, is used. As to the method of tracking, methods other than the land and groove method, for example, a sample servo method or the like may be used. Furthermore, similar results are obtained by use of not only the 8-16 modulation method but also modulation methods not described herein, such as a 1-7 modulation method, and also by use of signals including no dummy data.

According to the technology of the present invention, as to the positions of the respective contact pins 4, a contact part thereof can be provided within a small area of the diameter 23 mm to 33 mm on the inner circumference of the disk, which is more preferable. The area is called a cramp area in the conventional disk, and is used for fixing the disk. Thus, an information recording and reading apparatus having a power feeding mechanism according to the present invention makes it possible to not only perform recording and/or reading of a layer-selection-type optical disk but also to perform recording and/or reading of an existing optical disk, such as a DVD, which requires no power feeding. In other words, the information recording and reading apparatus according to the present invention makes it possible to have compatibility.

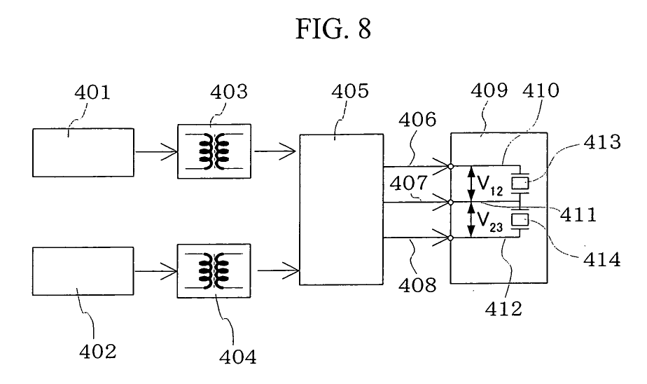

Next, with reference to FIGS. 8 to 10, an operation of switching recording layers will be described. FIG. 8 is a block diagram showing an electric circuit required for switching recording layers according to the first embodiment of the present invention. Both of an alternating-current power supply circuit 401 and a switching signal generation circuit 402 are mounted, as electronic circuits, on the circuit board 19.

The alternating-current power supply circuit 401 is a circuit for generating an alternating voltage required for electromagnetic induction, and a switching power source having an amplitude of 12V and a frequency of 100 kHz is used in this embodiment. The alternating voltage generated by the alternating-current power supply circuit 401 is supplied to a rotary transformer 403 for supplying power. The power transmitted to a rotating body by electromagnetic induction action of the rotary transformer 403 is supplied to a current control circuit board 405. Here, the rotary transformer 403 for supplying the power includes the rotor-side power supply coil 101, the rotor-side core 103, the stator-side power supply coil 104 and the stator-side core 106 in the configuration example shown in FIG. 1. As to the frequency of the alternating-current power supply, frequencies other than 100 kHz can be used to perform the operation. However, in order to avoid interference thereof with a servo frequency of the optical disk, the frequency of 100 kHz or less is more preferable.

Meanwhile, the switching signal generation circuit 402 is a circuit for generating signals for determining to which one of the recording layers the power is to be supplied. In the first embodiment, in order to avoid interference with the alternating-current power supply described above, signals having amplitude of 5V and a frequency in a range of 500 to 1000 kHz are generated. The signals are transmitted to a rotary transformer 404 for supplying signals. Moreover, the signals transmitted to a rotating body by electromagnetic induction action of the rotary transformer 404 are supplied to the current control circuit board 405. Here, the rotary transformer 404 includes the rotor-side signal supply coil 102, the rotor-side core 103, the stator-side signal supply coil 105 and the stator-side core 106 in the configuration example shown in FIG. 1. As to the frequency of each of the switching signals, frequencies other than that in the range of 500 to 1000 kHz can be used to perform the operation. However, it is preferable that a signal frequency of the optical disk be not chosen for the frequency of the switching signals. Here, frequencies higher than 1 MHz are avoided. This is to prevent noise from leaking into the signals.

The current control circuit board 405 includes a circuit for rectifying the supplied alternating-current power, and for converting the power into a direct current. Moreover, to the current control circuit board 405, a switching circuit is provided for determining to which one of the recording layers the converted direct current is to be supplied. According to the amplitude and frequency of each of the signals supplied from the rotary transformer 404, the recording layer to which the direct current is to be supplied is determined. Hence, the current is supplied to a first contact pin 406, a second contact pin 407 and a third contact pin 408, which are provided on the circuit board 405.

The first contact pin 406, the second contact pin 407 and the third contact pin 408 are respectively connected to a first concentric electrode 410, a second concentric electrode 411 and a third concentric electrode 412, which are provided to a surface of a layer-selection-type multi information layer optical disk 409. The direct current, of which the amplitude and time are controlled by the control circuit 405 described above, is supplied to a first recording layer 413 and to a second recording layer 414 through the electrodes described above.

Next, descriptions will be provided for timings of switching the current supplied to the first and second recording layers 413 and 414. It is supposed that a voltage applied to the first recording layer 413 is V₁₂, and a voltage applied to the second recording layer 414 is V₂₃.

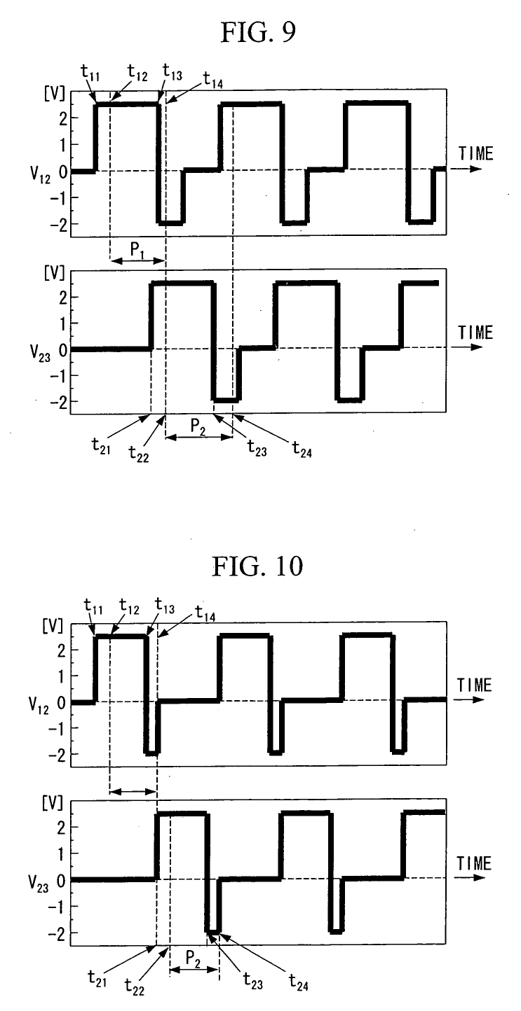

FIG. 9 is a graph showing changes in V₁₂ and V₂₃ over time in a first switching method. First, at a time t₁₁, V₁₂ is increased from 0V to 2.5V. Accordingly, a voltage is applied to the first recording layer 413 to change a state of the first recording layer 413 from transparent to colored. At a time t₁₂, coloring of the entire surface of the disk is completed. Next, at a time t₁₃, V₁₂ is lowered from 2.5V to −2V. As described above, application of the voltage opposite to that for coloring the recording layers leads to an effect of shortening time required for a change of the state of each of the recording layers from colored to transparent. At a time t₁₄, decoloring of the entire surface of the disk is completed, and the entire first recording layer 413 is returned to the transparent state. The time required to complete the decoloring after the coloring is completed is defined as P₁.

Next, at a time t₂₁, V₂₃ is increased from 0V to 2.5V. Accordingly, a voltage is applied to the second recording layer 414 to change a state of the second recording layer 414 from transparent to colored. At a time t₂₂, coloring of the entire surface of the disk is completed. Next, at a time t₂₃, V₂₃ is lowered from 2.5V to −2V. This reverse voltage leads to an effect of shortening time required for a change of the state of the second recording layer 414 from colored to transparent, as in the case of V₁₂. At a time t₂₄, decoloring of the entire surface of the disk is completed, and the entire second recording layer 414 is returned to the transparent state. The time required to complete the decoloring after the coloring is completed is defined as P₂.

In the first embodiment, control timing is determined for minimizing a difference between the time t₁₄ when the decoloring of the first recording layer 413 is completed and the time t₂₂ when the coloring of the second recording layer 414 is completed. Specifically, the time t₂₁ when the voltage is applied to the second recording layer 414 is set to occur before t₁₄.

Accordingly, it is possible to shorten time between the time P₁ for which the first recording layer 413 is set in the colored state and the time P₂ for which the second recording layer 414 is set in the colored state. As in the case of this embodiment, it is ideal to be able to immediately shift to P₂ without a time lag after P₁. By controlling the current by the timings as described above, time required for shifting from a recording and reading state of the first recording layer 413 to a recording and reading state of the second recording layer 414 can be shortened to the minimum. Thus, it is made possible to realize high-speed recording and reading of a layer-selection-type multi information layer optical disk apparatus.

FIG. 10 is a graph showing changes in V₁₂ and V₂₃ over time in a second switching method. In the first embodiment, control timing is determined for minimizing a difference between the time t₁₄ when the decoloring of the first recording layer 413 is completed and the time t₂₁ when the voltage is applied to the second recording layer 414.

The second switching method is disadvantageous for shortening the time for switching the recording layers since there is a certain period of time between P₁ and P₂. However, since the voltage is supplied to V₂₃ after V₁₂ is set in the state of 0V, it is no longer necessary to provide a circuit for simultaneously applying voltages respectively to both of V₁₂ and V₂₃. By controlling the current with the timings as described above, the power is no longer simultaneously supplied to the first and second recording layers. Thus, the circuit configuration can be simplified, and the power supply to the entire disk can be reduced.

FIG. 2 is a cross-sectional view of the information recording apparatus according to the first embodiment of the present invention, showing a case where force is applied to the fixing board when the medium is mounted on the fixing board. When force F for attaching the disk 1 is applied downward, the fixing board 3 and the circuit board 6 are slightly tilted downward with respect to the rotation axis 2 as shown in FIG. 2. However, the flexible substrate 9 has a flexible and deformable structure, and a space is provided between the fixing board 3 and the hub 10, except for the area where the rotation axis 2 is provided, the space being where the fixing board and the hub are not in contact with each other. With the above configuration, a tilt angle of the hub 10 is set smaller than a tilt angle of the fixing board 3 and of the circuit board 6.

As a result, the cores 103 and 106 facing each other with a space g of about 30 μm therebetween are less likely to be in contact with each other, or to mesh with each other. For the above reason, even when the operation of attaching the disk 1 is repeated, the disk 1 can be rotated stably for a long period of time by use of the configuration described above.

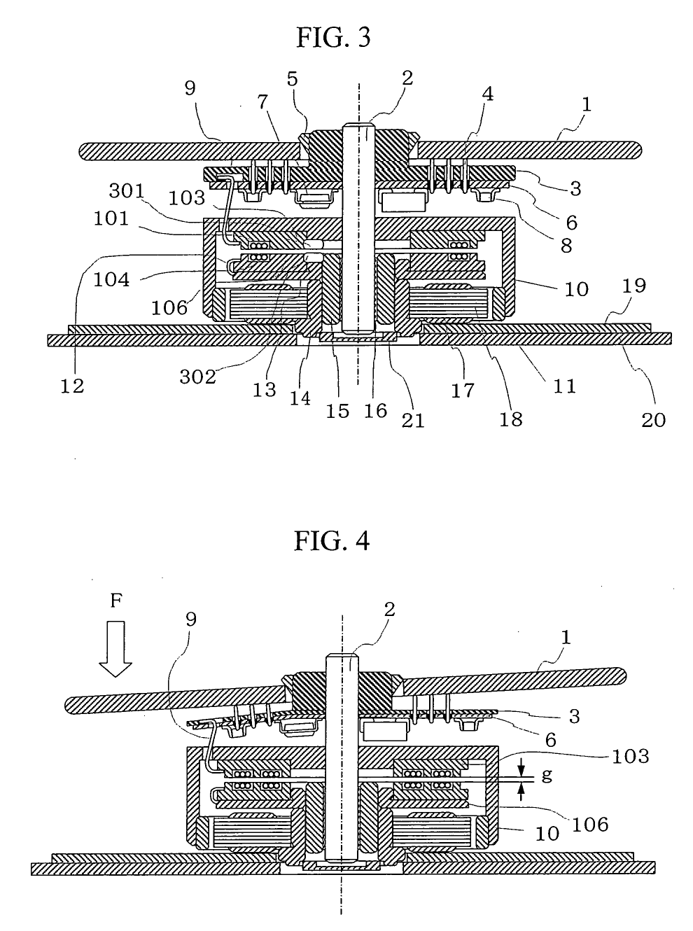

FIG. 3 is a cross-sectional view of an information recording apparatus according to a second embodiment of the present invention. In this embodiment, in order to supply control signals to a current control circuit board 6, a light emitting element and a light receiving element are used to transmit the signals.

A rotary transformer 100 is formed of the following parts, including a rotor-side power supply coil 101 and a rotor-side core 103; and a stator-side power supply coil 104 and a stator-side core 106, which are attached to a side of a stationary sleeve 13. Power supply to the current control circuit board 6 is achieved by electromagnetic induction between the coils 101 and 104, as in the case of FIG. 1.

A light emitting element 302 is attached to an inner circumferential side of the sleeve 13. A drive circuit for the light emitting element, which is mounted on a circuit board 19, controls the light emitting element 302 for light to be irradiated or to be stopped. A light receiving element 301 is attached to an inner circumferential side of a hub 10, the light receiving element 301 receiving light irradiated from the light emitting element 302 to generate electromotive force corresponding to intensity of the light. An electrode of the light receiving element 301 is connected to the current control circuit board 6 through the flexible substrate 9. The electromotive force generated in the light receiving element 301 is amplified and converted inside the control circuit, and is utilized for switching recording layers and for controlling polarities of a current and current values.

In the second embodiment, the electromagnetic induction coils are used for supplying the power, and the optical elements are used for supplying the control signals. Thus, in principle, interference is prevented. Specifically, it is made possible to realize a control circuit highly resistant to electrical noise inside the recording apparatus and to electrical noise outside thereof.

Incidentally, in the second embodiment, the electromotive force is generated only at the moment when the light receiving element 301 faces a front face of the light emitting element 302. Hence, in a case where the hub 10 is rotated, for example, at a speed of 3600 revolutions per minute (60 revolutions per second), the electromotive force is generated in the light receiving element 301 at a period of 1/60 sec=16.7 msec. The configuration shown in FIG. 3 is sufficient unless current needs to be controlled at a period shorter than 16.7 msec.

In a case where it is necessary to control the current at a period shorter than that described above, the structure may be altered to the following structure.
(1) A plurality of light receiving elements 301 are installed in an inner circumferential part of the hub 10.
(2) The light emitting element 302 and the light receiving elements 301 are respectively placed in positions through which the center of the rotation axis 2 passes. For example,
   The light emitting element 302 is mounted in the position through which the center of the rotation axis 2 on a cap 21 passes, and the light receiving elements 301 are mounted on a bottom surface of the rotation axis 2. Furthermore, a wiring is previously provided inside the rotation axis 2, and the light receiving elements 301 and the current control circuit board 6 are connected to each other by use of the wiring. Alternatively,
   A case cover is provided to a side opposite to that of a base 20, and a wiring is provided inside the cover. The light emitting element 302 is mounted on a surface of the cover in the position through which the center of the rotation axis 2 passes. Meanwhile, the light receiving elements 301 are mounted on an upper surface of the rotation axis 2, and a wiring is previously provided inside the rotation axis 2. The light receiving element 301 and the current control circuit board 6 are connected to each other.

Accordingly, the length of time for which the light emitting element and one of the light receiving elements face each other is increased. Thus, the current can be controlled at a shorter time period.

FIG. 4 is a cross-sectional view of an information recording apparatus according to a third embodiment of the present invention. In this embodiment, a fixing board 3 and a current control circuit board 6 are formed to have a structure flexible for external force F. Hence, a tilt angle of a hub 10 can be set smaller than a tilt angle of the fixing board 3 and of the circuit board 6. A disk made of an organic resin, which is thinner than a disk 1, for example, may be used as the fixing board 3. A flexible circuit board made of a polyimide resin may be used as the circuit board 6.

As a result, cores 103 and 106 facing each other with a space g of about 30 μm therebetween are less likely to be in contact with each other, or to mesh with each other. For the above reason, even when the operation of attaching the disk 1 is repeated, the disk 1 can be rotated stably for a long period of time by use of the configuration described above.

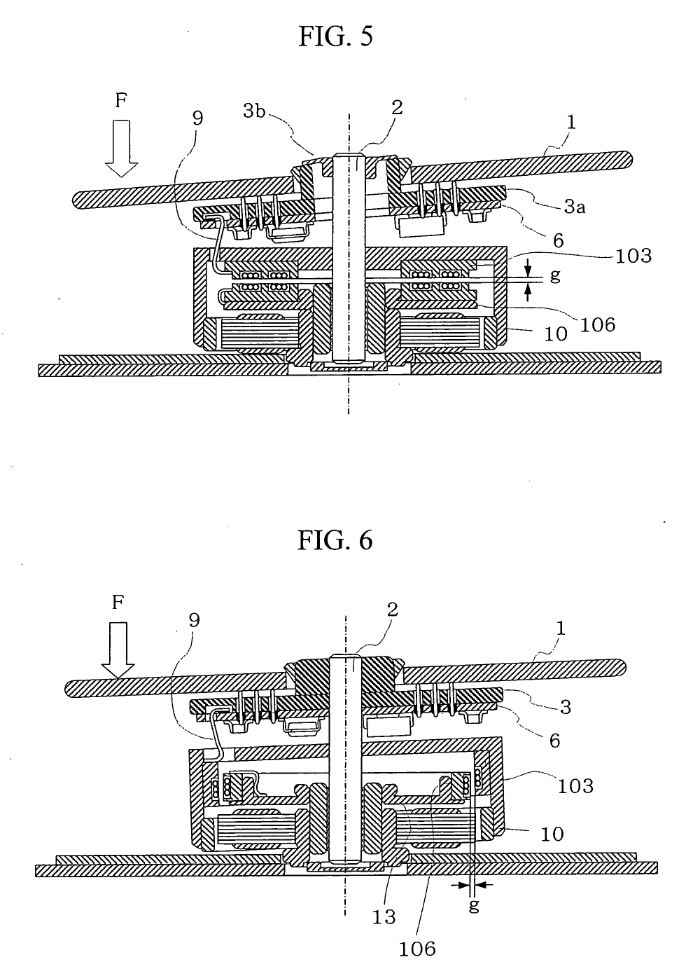

FIG. 5 is a cross-sectional view of an information recording apparatus according to a fourth embodiment of the present invention. In this embodiment, a fixing board 3 is formed of two parts which are a fixing board outer circumferential part 3a and a fixing board inner circumferential part 3b. The fixing board outer circumferential part 3a and the fixing board inner circumferential part 3b are previously bonded to each other, and the fixing board inner circumferential part 3b is press-fitted to a rotation axis 2.

By reducing a thickness of a part of the fixing board inner circumferential part 3b, a structure flexible to external force F can be obtained. Accordingly, a tilt angle of a hub 10 can be set smaller than a tilt angle of the fixing board 3 and of a circuit board 6.

As a result, cores 103 and 106 facing each other with a space g of about 30 μm therebetween are less likely to be in contact with each other, or to mesh with each other. For the above reason, even when the operation of attaching the disk 1 is repeated, the disk 1 can be rotated stably for a long period of time by use of the configuration described above.

FIG. 6 is a cross-sectional view of an information recording apparatus according to a fifth embodiment of the present invention. In this embodiment, a hub 10 at a rotation side and a sleeve 13 at a stationary side are caused to face each other on a plane parallel to a rotation axis 2, and cores 103 and 106 are mounted on the respective sides of the plane. Accordingly, even when a fixing board 3 and a circuit board 6 are tilted by force F, the cores 103 and 106 are shifted approximately parallel to the plane. Hence, a change in a space g between the cores is reduced. As a result, the cores 103 and 106 are less likely to be in contact with each other, or to mesh with each other. For the above reason, even when the operation of attaching the disk 1 is repeated, the disk 1 can be rotated stably for a long period of time by use of the configuration described above.

The embodiments described above are not limited to the layer-selection-type multi information layer optical disk, and are applicable to general storage devices which require power supply to the respective media. The present invention is applicable, for example, to a magnetic disk drive, a magneto-optical disk drive, a magnetic disk drive assisted with an electric field, an optical disk drive and the like.

What is claimed is:

1. An information recording apparatus comprising:
a medium having a plurality of recording layers;
a current control circuit which selects one of the recording layers by controlling currents to be supplied to the respective plurality of recording layers; and
electromagnetic induction means for contactlessly supplying power from a power source to the medium.

2. The information recording apparatus according to claim 1, further comprising:
a rotating body holding the medium; and
an irrotational body rotatably supporting the rotating body,
the information recording apparatus wherein the electromagnetic induction means for supplying the power includes pairs of coils each provided to the rotating body and the irrotational body, and magnetic substances.

3. The information recording apparatus according to claim 2, wherein the pair of coils provided to the rotating body and that provided to the irrotational body respectively face the magnetic substances across a plane perpendicular to a rotation axis of the rotating body.

4. The information recording apparatus according to claim 2, wherein the pair of coils provided to the rotating body and that provided to the irrotational body respectively face the magnetic substances across a rotation plane extended in a direction of a rotation axis of the rotating body.

5. The information recording apparatus according to claim 2, wherein the current control circuit is provided to the rotating body.

6. The information recording apparatus according to claim 5, further comprising electromagnetic induction means for contactlessly supplying control signals from the irrotational body to the current control circuit provided to the rotating body.

7. The information recording apparatus according to claim 6, wherein the electromagnetic induction means for supplying the control signals includes pairs of coils each provided to the rotating body and the irrotational body, and magnetic substances.

8. The information recording apparatus according to claim 5, further comprising, as means for contactlessly supplying control signals from the irrotational body to the current control circuit provided to the rotating body:
light emitting means provided to the irrotational body; and
light receiving means provided to the rotating body.

9. The information recording apparatus according to claim 5, wherein
the rotating body includes a fixing board for fixing the medium and a hub for holding the electromagnetic induction means,
the current control circuit is provided to the fixing board, and
the current control circuit and the electromagnetic induction means are electrically connected to each other by use of a flexible substrate.

10. The information recording apparatus according to claim 9, wherein a space is provided between the fixing board and the hub in order that the electromagnetic induction means provided to the hub cannot be caused to be in contact with the irrotational body when the medium is fixed to the fixing board.

11. The information recording apparatus according to claim 9, wherein each of the fixing board and the current control circuit is formed to have a flexible structure in order that the electromagnetic induction means provided to the hub cannot be caused to be in contact with the irrotational body when the medium is fixed to the fixing board.

12. The information recording apparatus according to claim 9, wherein a connection part between the fixing board and a rotation axis of the rotating body is formed to have a flexible structure in order that the electromagnetic induction means provided to the hub cannot be caused to be in contact with the irrotational body when the medium is fixed to the fixing board.

13. The information recording apparatus according to claim 9, wherein, in a way that the electromagnetic induction means provided to the hub is not caused to be in contact with the irrotational body when the medium is fixed to the fixing board,
the rotating body and the irrotational body are caused to face each other on a plane parallel to a rotation axis of the rotating body, and
the electromagnetic induction means is provided to the plane.
